(19) United States
(12) Patent Application Publication
(10) Pub. No.: US 2026/0019490 A1
(43) Pub. Date: Jan. 15, 2026

(54) ACCESSORY DEVICES WITH AN ADJUSTABLE OPENING

(71) Applicant: Apple Inc., Cupertino, CA (US)

(72) Inventors: Joshua A. HOOVER, Boulder, CO (US); Alexandria COLELLA, Cupertino, CA (US); Andrea L. BLAKEMORE, San Francisco, CA (US); Anne-Marie HECK, San Francisco, CA (US); Derek C. SCHIPPER, Cupertino, CA (US); Donald L. OLMSTEAD, Aptos, CA (US); Jessica DU, Boulder, CO (US); Seul Bi KIM, San Mateo, CO (US); Kevin W. STANLEY, San Francisco, CA (US); Nicholas J. ROSS, Broomfield, CO (US); Sean M. COLE, Louisville, CO (US); Stephanie A. WHALEN, San Francisco, CA (US); Stephen T. SCHOOLEY, Menlo Park, CA (US); Travis C. PEDLEY, Scotts Valley, CA (US); Vishakh TALANKI, Boulder, CO (US)

(21) Appl. No.: 18/770,478

(22) Filed: Jul. 11, 2024

(51) Int. Cl. H04M 1/04

(52) U.S. Cl. CPC H04M 1/04

(57) ABSTRACT

An accessory device includes an opening designed to receive a cable assembly and adjust in size when the cable assembly is received. Prior to receiving the cable assembly, the opening is defined by an initial size and initial area. When the opening receives the cable assembly, the opening expands to a larger size, and larger area, to accept the cable assembly. The opening returns to its initial size and initial area when the cable assembly is removed. An adjustable opening allows for cable assemblies of different shapes and sizes. By utilizing an adjustable opening, the wall of the accessory device through which the opening is formed may be relatively thick while the opening is its initial size, but may become relatively thin during instances when the cable assembly is in the opening.

### TECHNICAL FIELD

This application is directed to accessory devices, and more particularly, to accessory devices with dynamically adjustable openings.

### BACKGROUND

Accessory devices may be used with electronic devices. For example, an accessory device may provide a protective cover for the electronic device and support the electronic device. Also, the electronic device may be covered in multiple regions by the accessory device. In order to charge an electronic device while the electronic device in positioned in the accessory device, some accessory devices include an opening.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a plan view of an embodiment of an accessory device, in accordance with one or more aspects of the present disclosure.

FIG. 2 illustrates a perspective view of the accessory device shown in FIG. 1, further showing an opening of the accessory device, in accordance with one or more aspects of the present disclosure.

FIG. 3 illustrates a plan view of an embodiment of an electronic device, in accordance with one or more aspects of the present disclosure.

FIG. 4 illustrates an enlarged view of an accessory device, showing dimensional information of an opening of the accessory device in an initial state, in accordance with one or more aspects of the present disclosure.

FIG. 5 illustrates a side view of the accessory device shown in FIG. 4, further showing an object, in accordance with one or more aspects of the present disclosure.

FIG. 6 illustrates an enlarged view of the accessory device shown in FIG. 4, showing dimensional information of the opening of the accessory device in an expanded state, in accordance with one or more aspects of the present disclosure.

FIG. 7 illustrates an enlarged view of an alternate embodiment of an accessory device, showing a material of the accessory device, in accordance with one or more aspects of the present disclosure.

FIG. 8 illustrates a partial cross sectional view of the accessory device shown in FIG. 7, showing additional features, in accordance with one or more aspects of the present disclosure.

FIG. 9 illustrates an enlarged view of an alternate embodiment of an accessory device, showing a material designed to compress, in accordance with one or more aspects of the present disclosure.

FIG. 10 illustrates an enlarged view of an alternate embodiment of an accessory device, showing a wall designed to deflect, in accordance with one or more aspects of the present disclosure.

FIG. 11 and FIG. 12 illustrate enlarged views of an alternate embodiment of an accessory device, showing an opening and several magnets, in accordance with one or more aspects of the present disclosure.

FIG. 13 and FIG. 14 illustrate enlarged cross sectional views of an alternate embodiment of an accessory device, showing an opening and a material designed to bend, in accordance with one or more aspects of the present disclosure.

FIG. 15 illustrates an enlarged partial cross sectional view of an alternate embodiment of an accessory device, showing an opening and a material with a structure embedded in the material, in accordance with one or more aspects of the present disclosure.

FIG. 16 and FIG. 17 illustrate enlarged views of an alternate embodiment of an accessory device, showing door portions of the accessory device in an initial state, in accordance with one or more aspects of the present disclosure.

FIG. 18 and FIG. 19 illustrate enlarged views of the accessory device shown in FIG. 16 and FIG. 17, showing door portions in an expanded state, in accordance with one or more aspects of the present disclosure.

FIG. 20 illustrates an enlarged view of an alternate embodiment of an accessory device, showing door portions of the accessory device designed to move in a different direction, in accordance with one or more aspects of the present disclosure.

FIG. 21 illustrates a plan view of an alternate embodiment of an accessory device, showing buttons integrated with accessory device to actuate door portions, in accordance with one or more aspects of the present disclosure.

FIG. 22 and FIG. 23 illustrate enlarged perspective views of alternate embodiments of an accessory device, showing an opening and a material, in accordance with one or more aspects of the present disclosure.

FIG. 24A and FIG. 24B illustrate side views of an embodiment of an accessory device, further showing the accessory device having a flap, in accordance with one or more aspects of the present disclosure.

FIG. 25A and FIG. 25B illustrate side views of an embodiment of an accessory device, further showing the accessory device having a flap, in accordance with one or more aspects of the present disclosure.

FIG. 26 illustrates a plan view of an embodiment of a lanyard, in accordance with one or more aspects of the present disclosure.

FIG. 27 illustrates a perspective view of an alternate embodiment of an accessory device, showing a lanyard secured with the accessory device, in accordance with one or more aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to accessory devices that include an adjustable opening (e.g., port) designed to adapt to various cables assemblies for electronic devices with which the disclosed accessory devices are used. Accessory devices described herein include several walls (e.g., bottom wall, sidewalls), with at least one of the walls having an opening designed to receive a cable assembly, thus allowing the cable assembly to connect (e.g., mechanically and electrically connect) with an electronic device. Generally, the wall with the opening is designed to be relatively thin, thus requiring the opening to accommodate all cable assemblies. For larger cable assemblies, at least some dimensions of the opening would exceed the size of the wall.

While the problem related to the opening can be solved by forcing users to use particular cable assemblies (e.g., smaller cable assemblies), accessory devices described herein may be designed with a dynamic opening that expands to adapt to and accept larger cable assemblies. As non-limiting examples (as will be discussed herein), an expanding opening may include compressible materials, bendable materials, foldable materials, magnets, or a combination thereof. Beneficially, an adjustable opening allows for cable assemblies of different shapes and sizes, thus minimizing or eliminating restrictions on cable assemblies. Moreover, subsequent to removal of the cable assembly from the electronic device and the accessory device, the opening may contract from its expanded state back to its initial state (e.g., original size). Based on the ability to contract, a dynamic opening may also be used to protect sensitive touch sensors from debris, dirt or oils. For example, an opening with a smaller area tends to permit fewer objects to pass therethrough. In addition to accessory devices, other devices, such as rings (e.g., bumpers) designed to provide sidewall protection and sleeves, may integrate a dynamic opening.

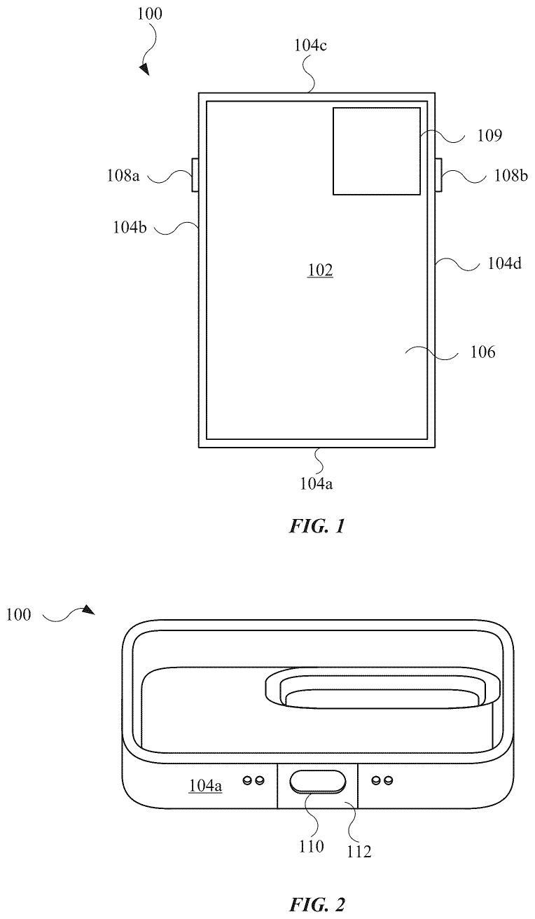

These and other embodiments are discussed below with reference to FIGS. 1-27. However, those skilled in the art will readily appreciate that the detailed description given herein with respect to these Figures is for explanatory purposes only and should not be construed as limiting.

FIG. 1 illustrates a plan view of an embodiment of an accessory device 100, in accordance with one or more aspects of the present disclosure. Accessory device 100 may take the form of a case or other accessory designed to receive an electronic device (not shown in FIG. 1), such as a mobile wireless communication device (e.g., smartphone, tablet computing device). As non-limiting examples, accessory device 100 may be formed from one or more materials such as silicone, polycarbonate, textile, microfiber, or a combination thereof.

Accessory device 100 may include several walls. For example, accessory device includes a wall 102, representative of a bottom wall, or back wall, of accessory device 100. Additionally, accessory device 100 may further includes several walls that extend from wall 102, such as a wall 104a, a wall 104b, a wall 104c, and a wall 104d. One or more of walls 104a, 104b, 104c, and 104d may combine with wall 102 to define a receptacle 106, with receptacle 106 functioning as a space to receive an electronic device.

Additionally, accessory device 100 may include one or more buttons. For example, accessory device 100 includes a button 108a and a button 108b. Each of buttons 108a and 108b may be positioned on a wall of one or more of walls 104a, 104b, 104c, and 104d. In particular, each of buttons 108a and 108b may be positioned at a location corresponding to a button of an electronic device. Also, accessory device 100 may further include an opening 109 for a camera assembly of an electronic device. As shown, opening 109 is formed in wall 102.

FIG. 2 illustrates a perspective view of accessory device 100 shown in FIG. 1, further showing an opening 110 of accessory device 100, in accordance with one or more aspects of the present disclosure. Opening 110 is designed to provide a location through which a cable assembly (not shown in FIG. 2) may pass through accessory device 100 to connect (e.g., mechanically and electrically connect) with an electronic device. Accordingly, opening 110 may be formed in wall 104a such that opening 110 is aligned with a corresponding opening and connector of the electronic device.

Further, wall 104a may include a material 112 through which opening 110 is formed. In some instances, material 112 takes the form of a compressible material or a material with a relatively low durometer. As non-limiting examples, material 112 may include a compressible textile, elastomer, or rubber. Material 112 may represent a different as compared to the material(s) used to form wall 104a that surrounds material 112.

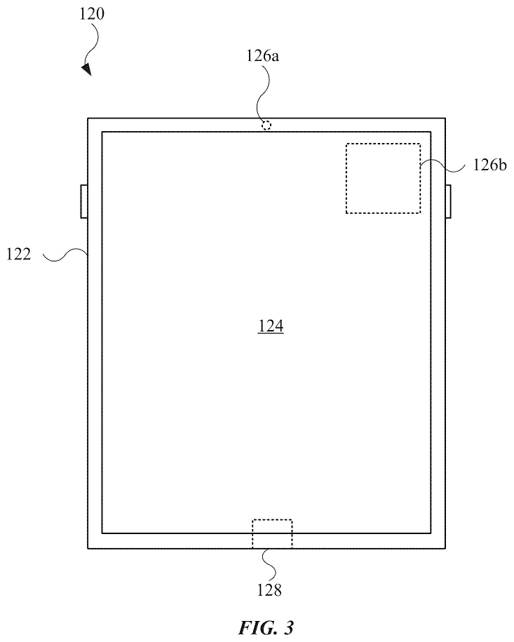

FIG. 3 illustrates a plan view of an embodiment of an electronic device 120, in accordance with one or more aspects of the present disclosure. Electronic device 120 may be inserted into receptacle 106 of accessory device 100 (shown in FIG. 1). Electronic device 120 may include a housing 122, or enclosure, designed to carry various components for electronic device 120. Electronic device 120 may further include a display 124 coupled with, and carried by, housing 122. Display 124 is designed present visual information in the form of text, still images, and/or motion images (e.g., video). Further, electronic device 120 may include a camera assembly 126a and a camera assembly 126b. Camera assembly 126a, representative of one or more cameras, may take the form of a front camera, or front-facing camera, designed to capture images of the environment facing display 124. Camera assembly 126b (shown as dotted lines), representative of one or more cameras, may take the form of a rear camera, or rear-facing camera, designed to capture images of the environment facing housing 122. Additionally, electronic device 120 may include port 128 designed to receive, and electrically and mechanically couple with, an object (e.g., cable assembly, shown below).

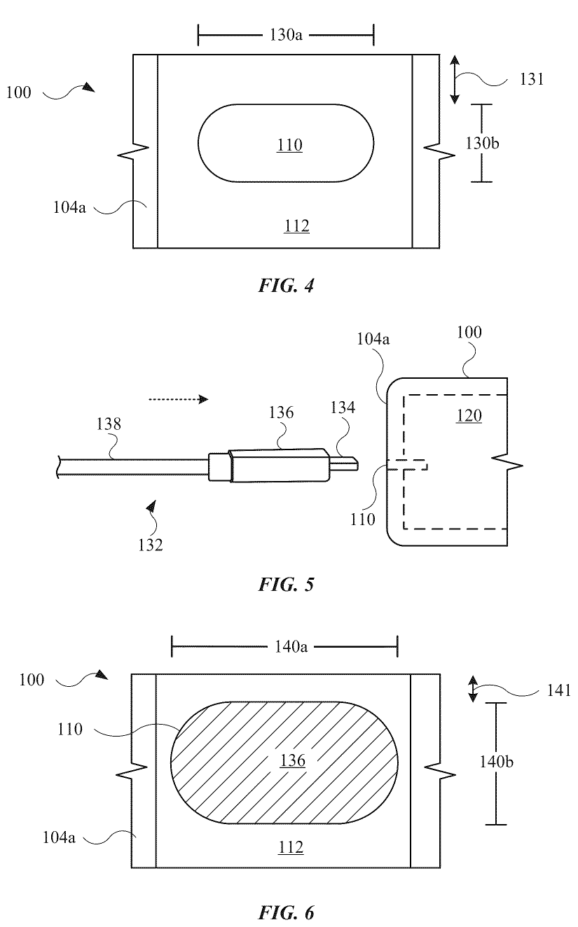

FIG. 4 illustrates an enlarged view of accessory device 100, showing dimensional information of opening 110 of accessory device 100 in an initial state, in accordance with one or more aspects of the present disclosure. The initial state of opening 110 may be referred to as a steady state in which generally no external forces, other than gravity, are acting upon material 112 at opening 110. Further, the initial state of opening 110 may define an area (e.g., initial area). As shown, opening 110 includes a dimension 130a (e.g., width) and a dimension 130b (e.g., height). Additionally, material 112 may represent a distance between upper and lower portions of wall 104a. For example, a dimension 131 represents a distance between an edge of opening 110 and an upper portion of wall 104a. Dimension 131 may be representative of a distance between an edge of opening 110 and a lower portion of wall 104a.

FIG. 5 illustrates a side view of accessory device 100 shown in FIG. 4, further showing an object 132, in accordance with one or more aspects of the present disclosure. In one or more implementations, object 132 takes the form of a cable assembly. In this regard, object 132 may include a connector 134, a boot 136, and a cord 138. Connector 134 is designed to enter wall 104a, via opening 110 of accessory device 100, to connect to electronic device 120. While connector 134 may fit through opening 110 with relative ease, boot 136 may inhibit, or at least partially inhibit, connector 134 from properly connecting to electronic device 120 based in part on the dimensions 130a and 130b of opening 110 (shown in FIG. 4). In this regard, multiple factors, such as the dimensions of an opening of an accessory device and the dimensions of a cable assembly, may contribute to issues related to connecting the cable assembly to an electronic device.

However, opening 110 of accessory device 100 is designed to adapt to object 132. For example, FIG. 6 illustrates an enlarged view of accessory device 100 shown in FIG. 4, showing dimensional information of opening 110 of the accessory device 100 in an expanded state, in accordance with one or more aspects of the present disclosure. As shown, object 132 (shown in FIG. 5) is in contact (e.g., engaged) with wall 104a of accessory device 100. In particular, boot 136 of object 132 is in contact with material 112, which causes the dimensions of opening 110 to change. For example, opening 110, in an expanded state, includes a dimension 140a (e.g., width) and a dimension 140b (e.g., height). Dimension 140a and dimension 140b may be greater than dimension 130a and dimension 130b (shown in FIG. 4), respectively. In this regard, the expanded state of opening 110 may define an area (e.g., expanded area) of opening 110 that is greater than the area of opening 110 in the initial state (shown in FIG. 4). Accordingly, opening 110 may expand such that opening 110 increases in at least two different dimensions. Beneficially, opening 110 allows accessory device 100 to adapt to objects of different sizes, and in some cases, objects of different shapes.

Conversely, material 112 may contract or compress, allowing opening 110 to transition to the expanded state as shown in FIG. 6. For example, a dimension 141 represents a thickness between an edge of opening 110 and an upper portion of wall 104a. Dimension 141 may be representative of a distance between an edge of opening 110 and a lower portion of wall 104a. As shown, dimension 141 of wall 104a is less than dimension 131 (shown in FIG. 4). It should be noted that when object 132 is removed, opening 110 returns (e.g., contract) to its original size as shown in FIG. 4.

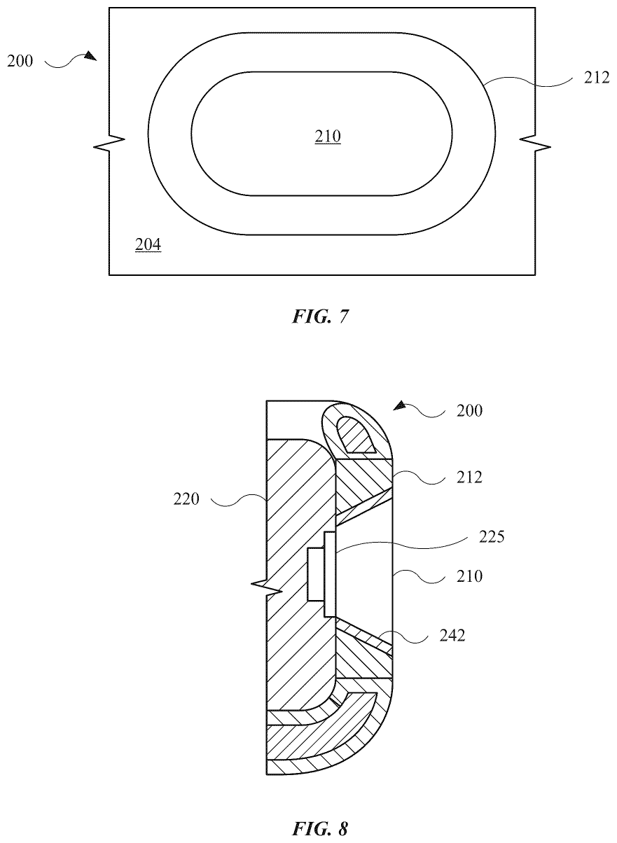

FIGS. 7-24 show and describe accessory devices with openings designed to adapt to objects. While not all features for accessory devices are shown and/or described in FIGS. 7-24, least some features (e.g., bottom wall, sidewalls) shown and described for the accessory device 100 (e.g., shown in FIG. 1) may be included in the accessory devices shown and described in FIGS. 7-24. Several exemplary embodiments of FIGS. 7-24 may show an opening of an accessory device in an initial state, corresponding to an initial area, transitioning to an expanded state, corresponding to an expanded area that is greater than the initial area.

FIG. 7 illustrates an enlarged view of an alternate embodiment of an accessory device 200, showing a material 212 of the accessory device, in accordance with one or more aspects of the present disclosure. As shown, accessory device 200 includes a wall 204 (e.g., sidewall), with material 212 integrated with wall 204 and defining an opening 210 used to receive an object (e.g., cable assembly). Material 212 may include one or more low-durometer materials designed to compress in response to being in contact with an object.

FIG. 8 illustrates a partial cross sectional view of accessory device 200 shown in FIG. 7, showing additional features, in accordance with one or more aspects of the present disclosure. As shown, an electronic device 220 is disposed (e.g., positioned) in accessory device 200, and opening 210 is aligned with an opening 225 of electronic device 220. When an object passes through opening 210 and contacts material 212, opening 210 may expand and adapt to the size and shape of the object. Further, material 212 may include additional features to facilitate adaptation to the object. For example, material 212 is chamfered (e.g., angled). In this regard, opening 210 may characterized as a chamfered opening. Still further, material 212 may include a coating 242. Coating 242 may include a lower coefficient of friction as compared to that of material 212. As a result, the object may more readily pass through opening 210.

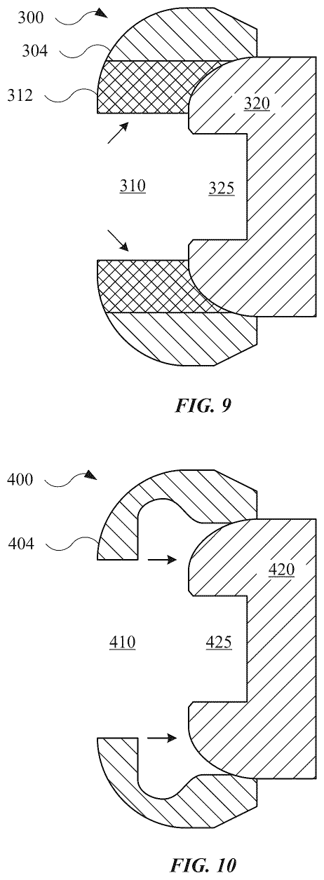

FIG. 9 illustrates an enlarged view of an alternate embodiment of an accessory device 300, showing a material 312 designed to compress, in accordance with one or more aspects of the present disclosure. As a non-limiting example, material 312 may include a compressible textile material. As shown, accessory device 300 includes a wall 304 with an opening 310 defined by material 312. Further, opening 310 is designed to align with an opening 325 of an electronic device 320 when electronic device 320 is disposed in accessory device 300, as shown in FIG. 9. When an object (e.g., cable assembly) enters opening 310, the object may contact material 312, causing material 312 to compress and further causing opening 310 to expand. The compression of material 312 and expansion of opening 310 are generally denoted by the direction of arrows.

FIG. 10 illustrates an enlarged view of an alternate embodiment of an accessory device 400, showing a wall 404 designed to deflect, in accordance with one or more aspects of the present disclosure. As shown, accessory device 400 includes a wall 404 with an opening 410 defined by wall 404. Opening 410 is designed to align with an opening 425 of an electronic device 420 when electronic device 420 is disposed in accessory device 400, as shown in FIG. 10. In the example embodiment, wall 404 is separated from electronic device 420 by a gap. In this regard, when an object (e.g., cable assembly) enters opening 410, the object may contact wall 404, causing wall 404 to bend, or deflect, and further causing opening 410 to expand. The deflection of wall 404 is generally denoted by the direction of arrows. While wall 404 is generally shown as a unitary material, wall 404 may include one or more additional materials, such as a textile and/or an elastomer, with the textile and/or elastomer designed to deflect in response to contact with an object.

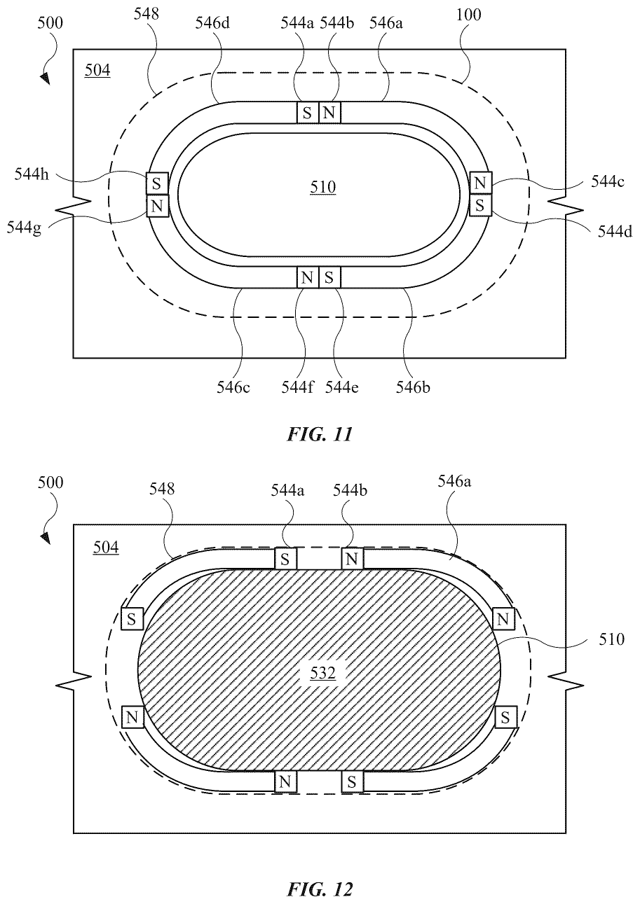

FIG. 11 and FIG. 12 illustrate enlarged views of an alternate embodiment of an accessory device 500, showing an opening 510 and several magnets, in accordance with one or more aspects of the present disclosure. Referring to FIG. 11, accessory device 500 includes a wall 504 that defines opening 510. Accessory device 500 may include several magnets that surround opening 510. For example, accessory device 500 includes a magnet 544a and a magnet 544b magnetically coupled with magnet 544a, a magnet 544c and a magnet 544d magnetically coupled with magnet 544c, a magnet 544e and a magnet 544f magnetically coupled with magnet 544c, and a magnet 544g and a magnet 544h magnetically coupled with magnet 544g. Each of the magnets is shown with an “N” or an “S”, representing a North-facing Pole or South-facing Pole, respectively. However, the “N” and “S” are intended to convey that adjacent magnets have opposite poles aligned with each other and will magnetically couple with each other. Each of the magnets may couple with a material. For example, magnets 544b and 544c couple with a material 546a, magnets 544d and 544e couple with a material 546b, magnets 544f and 544g couple with a material 546c, and magnets 544h and 544a couple with a material 546d. As a non-limiting example, each of materials 546a, 546b, 546c, and 546d may take the form of a string, including an elastomer string. Also, each of the aforementioned magnets and materials may be disposed in a pocket 548, or void, formed in wall 504.

Referring to FIG. 12, an object 532 is positioned in opening 510, causing the magnets to separate. For example, the force provided by object 532 when positioned in opening 510 causes the opening 510 to expand, and further causes magnets 544a and 544b decouple (e.g., magnetically decouple) from each other. The decoupling between magnets 544a and 544b is representative of decouple of the other magnets shown in FIG. 12. Further, the materials 546a, representative of the other materials shown in FIG. 12, may compress or collapse. Pocket 548 provides space in which the magnets and materials may move throughout. When the object 532 is removed from the opening 510, the opening 510 may return to its initial state and the magnets may again couple with each other, as shown in FIG. 11.

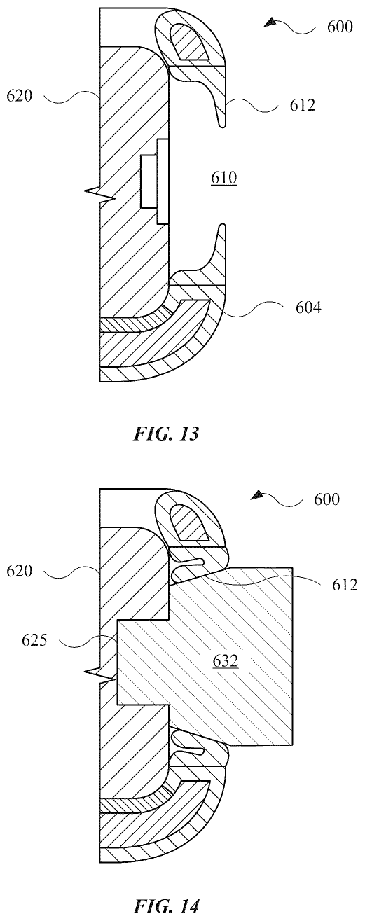

FIG. 13 and FIG. 14 illustrate enlarged partial cross sectional views of an alternate embodiment of an accessory device 600, showing an opening 610 and a material 612 designed to bend, in accordance with one or more aspects of the present disclosure. As shown, accessory device 600 includes a wall 604, which includes material 612. Also, an electronic device 620 is positioned in accessory device 600. Referring to FIG. 13, material 612 may take the form of a flap designed to bend or fold in response to a force. Material 612 may include an elastomer, as a non-limiting example. Further, material 612 may define opening 610, including a size and shape of opening 610. Additionally, opening 610 may be characterized as being in an initial state, and material 612 may be characterized as being in an expanded state.

Referring to FIG. 14, an object 632 passes through opening 610 (labeled in FIG. 13) and contacts material 612, and is positioned an opening 625 of electronic device 620. Based on contact with object 632, material 612 bends or folds. As a result, opening 610 expands and may be characterized as being in an expanded state, while material 612 may be characterized as being in a contracted state.

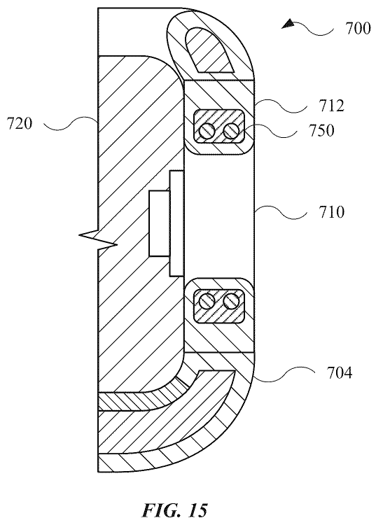

FIG. 15 illustrates an enlarged partial cross sectional view of an alternate embodiment of an accessory device 700, showing an opening 710 and a material 712 with a structure 750 embedded in the material, in accordance with one or more aspects of the present disclosure. As shown, accessory device 700 includes a wall 704 and material 712 extends from wall 704. Also, an electronic device 720 is positioned in accessory device 700. Structure 750 may take the form of a compressible ring that includes elastomer or rubber, as non-limiting examples. When an object (not shown in FIG. 15) contacts material 712, structure 750 may compress, thus allowing opening 710 to expand.

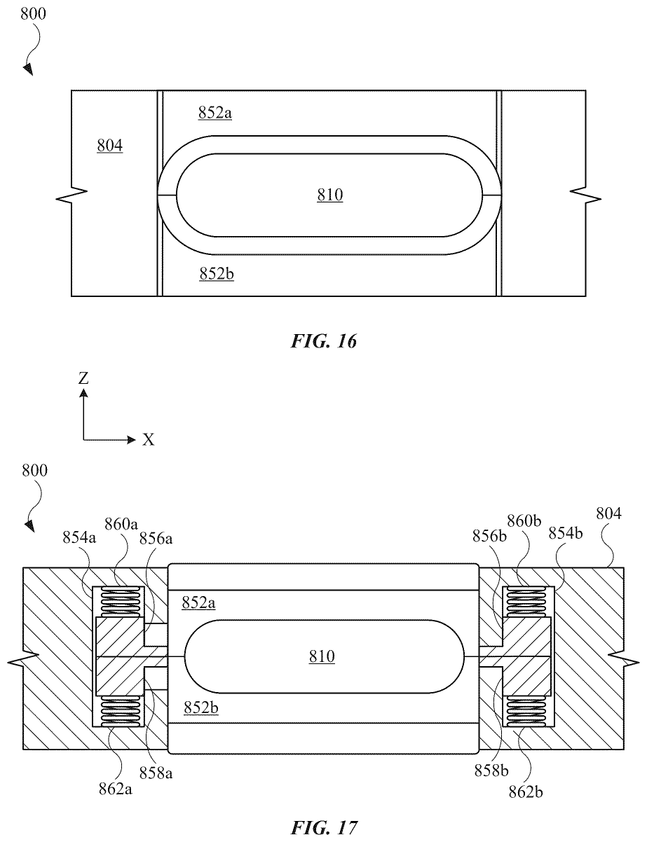

FIG. 16 and FIG. 17 illustrate enlarged views of an alternate embodiment of an accessory device 800, showing door portions of accessory device 800 in an initial state, in accordance with one or more aspects of the present disclosure. Accessory device 800 may include a wall 804 that include a door portion 852a and a door portion 852b. Referring to FIG. 16, an exterior view of accessory device 800 shows door portions 852a and 852b may combine to form an opening 810 designed to receive an object, such as a cable assembly (not shown in FIG. 16). Also, each of door portions 852a and 852b may be chamfered, and accordingly, opening 810 may be characterized as a chamfered opening. As shown, door portion 852a may contact door portion 852b, and opening 810 is in an initial state.

Referring to FIG. 17, an interior view showing a partial cross section of accessory device 800 shows wall 804 having a rail 854a and a rail 854b. Additionally, door portion 852a includes an extension 856a and an extension 856b located in rail 854a and rail 854b, respectively. Further, door portion 852b includes an extension 858a and an extension 858b located in rail 854a and rail 854b, respectively. Extensions 856a, 856b, 858a and 858b may each be characterized as a lozenge. Rail 854a may function as a guide for extensions 856a and 858a, while rail 854b may function as a guide for extensions 856b and 858b. Still further, accessory device 800 may include a biasing mechanism 860a and a biasing mechanism 860b located in rail 854a and rail 854b, respectively, and coupled with extension 856a and extension 856b, respectively. Also, accessory device 800 may include a biasing mechanism 862a and a biasing mechanism 862b located in rail 854a and rail 854b, respectively, and coupled with extension 858a and extension 858b, respectively. Each of biasing mechanisms 860a, 860b, 862a and 862b may take the form of a spring.

Opening 810 may be characterized as being in an initial state. In this regard, biasing mechanism 860a and 860b provide a force (e.g., spring force) to extension 856a and extension 856b, respectively, along a negative direction of a Z-axis (of Cartesian coordinates). Simultaneously, biasing mechanism 862a and 862b provide a force to extension 858a and extension 858b, respectively, along a positive direction of the Z-axis. As a result, door portions 852a and 852b may remain engaged with each other.

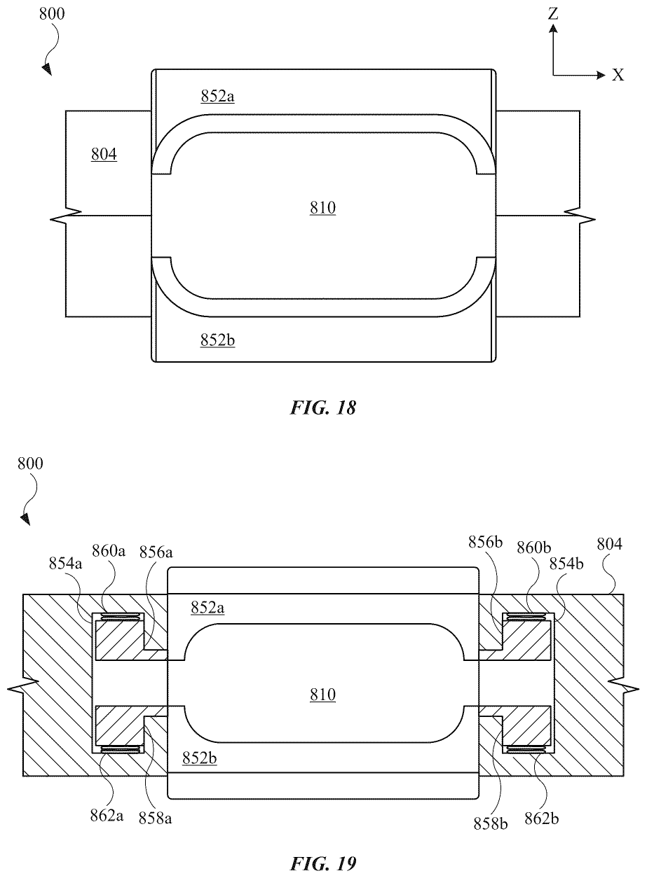

FIG. 18 and FIG. 19 illustrate enlarged views of accessory device 800 shown in FIG. 16 and FIG. 17, showing door portions 852a and 852b in an expanded state, in accordance with one or more aspects of the present disclosure. For purposes of simplicity, an object in opening 810 is now shown. Referring to FIG. 18, door portions 852a and 852b may traverse along the Z-axis, with door portion 852a traversing along the positive direction of the Z-axis and door portion 852b traversing along the negative direction of the Z-axis. Accordingly, in response to contact with an object, door portions 852a and 852b move in opposite directions, thus causing opening 810 to transition to an expanded state.

Referring to FIG. 19, based on door portions 852a and 852b moving in opposite directions (and with respect to wall 804), extension 856a and extension 856b may move along rail 854a and rail 854b, respectively, may causing biasing mechanism 860a and biasing mechanism 860b, respectively, to compress. Similarly, extension 858a and extension 858b may move along rail 854a and rail 854b, respectively, causing biasing mechanism 862a and biasing mechanism 862b, respectively, to compress. When the object is removed from opening 810, door portions 852a and 852b may return to their prior positions (e.g., shown in FIGS. 16 and 17).

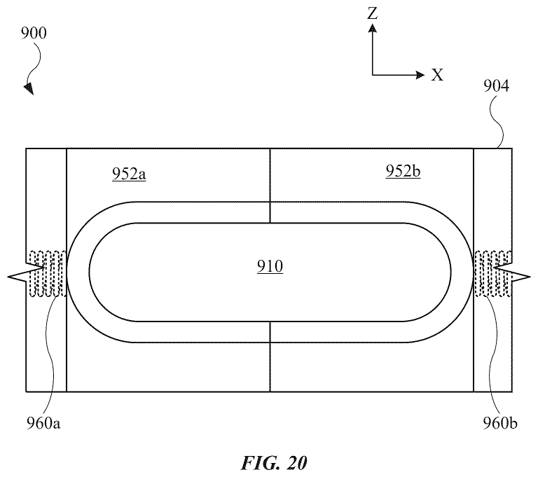

FIG. 20 illustrates an enlarged view of an alternate embodiment of an accessory device 900, showing door portions of accessory device 900 designed to move in a different direction, in accordance with one or more aspects of the present disclosure. Accessory device 900 may include a wall 904 that include a door portion 952a and a door portion 952b. As shown, door portions 952a and 952b may combine to form an opening 910 designed to receive an object, such as a cable assembly (not shown in FIG. 20). Also, each of door portions 952a and 952b may be chamfered, and accordingly, opening 910 may be characterized as a chamfered opening. Also, door portion 952a may contact door portion 952b, and opening 910 is in an initial state. Biasing mechanism 960a may provide a force (e.g., spring force) to door portion 952a along a positive direction of an X-axis, and biasing mechanism 960b may provide a force (e.g., spring force) to door portion 952b along a negative direction of the X-axis, thus causing door portions 952a and 952b to engage each other and maintaining opening 910 in an initial state. However, an object that enters opening 910 and contacts door portions 952a and 952b may further provide a force that compresses biasing mechanisms 960a and 960b, thus causing door portions 952a and 952b to separate and opening 910 to transition to an expanded state.

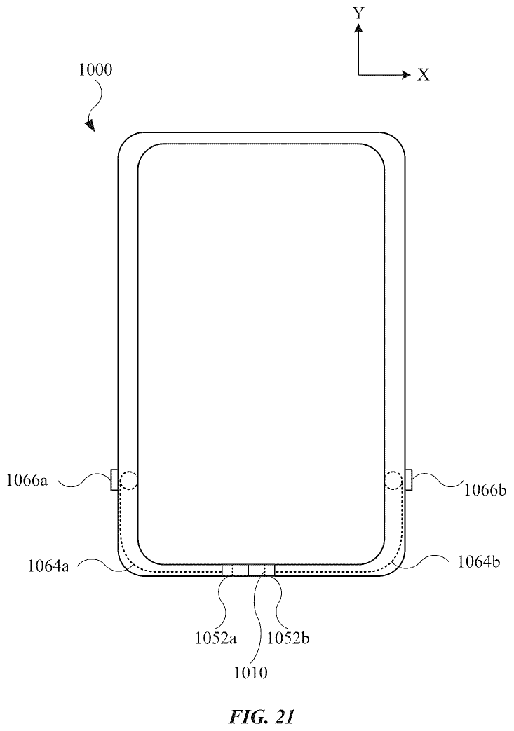

FIG. 21 illustrates a plan view of an alternate embodiment of an accessory device 1000, showing buttons integrated with accessory device 1000 to actuate door portions, in accordance with one or more aspects of the present disclosure. As shown, accessory device 1000 includes a wall 1004 that includes a door portion 1052a and a door portion 1052b, similar to door portion 952a and door portion 952b, respectively (shown in FIG. 20). In this regard, door portions 1052a and 1052b may define an opening 1010. Accessory device 1000 may further include a wire 1064a and a wire 1064b coupled with door portion 1052a and door portion 1052b, respectively. Accessory device 1000 may further include a button 1066a and a button 1066b coupled with wire 1064a and wire 1064b, respectively. By depressing button 1066a and button 1066b, door portion 1052a and door portion 1052b may move away from each other (e.g., along opposing directions of the X-axis). As a result, opening 1010 may expand to receive an object (e.g., cable assembly).

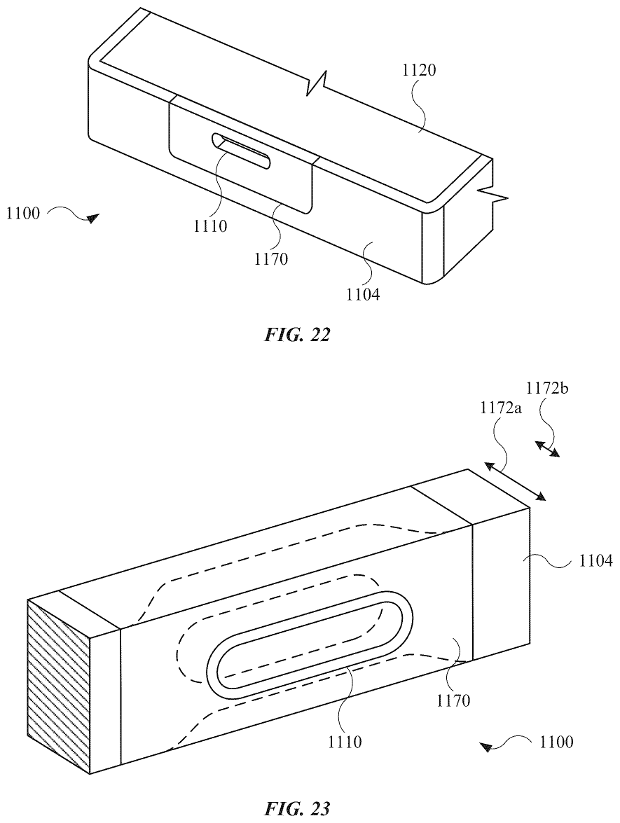

FIG. 22 and FIG. 23 illustrate enlarged perspective views of alternate embodiments of an accessory device 1100, showing an opening and a material, in accordance with one or more aspects of the present disclosure. Referring to FIG. 22, an accessory device 1100 includes a wall 1104. Wall 1104 may include a material 1170 that defines an opening 1110. As non-limiting examples, material 1170 takes the form of a mesh material, an elastomer, or rubber. In this regard, material 1170 may become displaced in response to an object (e.g., cable assembly) passing through opening 1110 and contacting material 1170. Based on the displacement of material 1170, the object is permitted to pass through opening 1110 to connect to an electronic device 1120 positioned in accessory device 1100.

Referring to FIG. 23, the dotted lines show a location material 1170 while material 1170 is compressed, which may occur when an object enters opening 1110 and contacts material 1170. Material 1170 may return to its original state (e.g., shown in FIG. 22) when the object is removed. Conversely, in one or more implementations, material 1170 may be relatively thin as compared to wall 1104. For example, wall 1104 may include a dimension 1172a (e.g., thickness) and material 1170 may be pre-formed having a dimension 1172b that is less than dimension 1172a. Put another way, the dotted lines may represent the shape of material 1170 without any external forces other than gravity acting on material 1170. As a result, the reduced thickness of material 1170 may facilitate inserting an object into opening 1110.

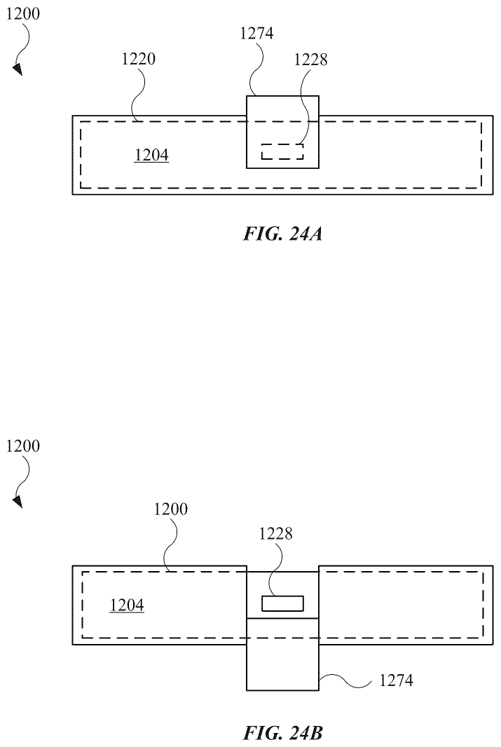

FIG. 24A and FIG. 24B illustrate side views of an embodiment of an accessory device 1200, further showing accessory device 1200 having a flap 1274, in accordance with one or more aspects of the present disclosure. As shown, accessory device 1200 is carrying an electronic device 1220. Also, accessory device 1200 may include a wall 1204 and flap 1274 is coupled (e.g., rotatably coupled) with wall 1204.

Referring to FIG. 24A, flap 1274 may cover a port 1228 of electronic device 1220. Referring to FIG. 24B, flap 1274 may be rotated away from wall 1204 to reveal port 1228.

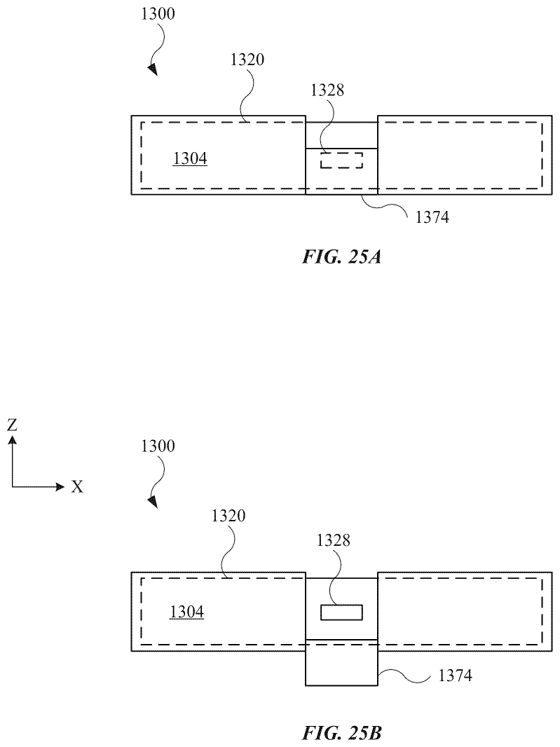

FIG. 25A and FIG. 25B illustrate side views of an embodiment of an accessory device 1300, further showing accessory device 1300 having a flap 1374, in accordance with one or more aspects of the present disclosure. As shown, accessory device 1300 is carrying an electronic device 1320. Also, accessory device 1300 may include a wall 1304 and flap 1374 is coupled with wall 1304.

Referring to FIG. 25A, flap 1374 may cover a port 1328 of electronic device 1320. Referring to FIG. 25B, flap 1374 may be moved or pulled downward (e.g., along the negative Z-direction) relative to wall 1304 to reveal port 1328.

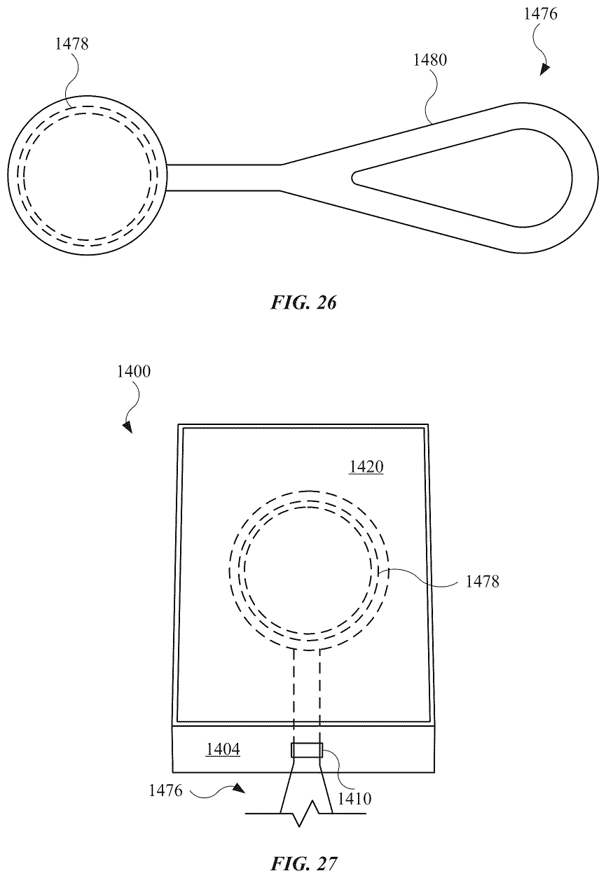

FIG. 26 illustrates a plan view of an embodiment of a lanyard 1476, in accordance with one or more aspects of the present disclosure. Lanyard 1476 may be designed to be worn on a user. As shown, lanyard 1476 includes a plate 1478 and a loop 1480. In one or more implementations, plate 1478 takes the form of a magnetic plate. In this regard, plate 1478 may include one or more magnets, or one or more metal plates that is/are magnetically attracted to magnets. Loop 1480 may fit around a user.

FIG. 27 illustrates a perspective view of an alternate embodiment of an accessory device 1400, showing lanyard 1476 secured with accessory device 1400, in accordance with one or more aspects of the present disclosure. As shown, accessory device 1400 is carrying an electronic device 1420. Also, accessory device 1400 may include a wall 1404 and an opening 1410 formed in wall 1404. In order to receive lanyard 1476, opening 1410 may expand, as shown and/or described in prior embodiments for an accessory device. For example, plate 1478 may be positioned in a volume or space that holds electronic device 1420 prior to accessory device 1400 receiving electronic device 1420, and loop 1480 may be folded and passed through opening 1410. Additionally, accessory device 1400 and/or electronic device 1420 may include one or more magnets (not shown in FIG. 27), and plate 1478 may magnetically couple with the one or more magnets of accessory device 1400 and/or electronic device 1420, respectively.

Various examples of aspects of the disclosure are described below as clauses for convenience. These are provided as examples, and do not limit the subject technology.

Clause A: An accessory device includes one or more walls that define a receptacle for an electronic device. The one or more walls including an opening having a first area. In response to receiving an object configured to connect to the electronic device, the opening transitions to a second area different from the first area.

Clause B: An accessory device includes a bottom wall. The accessory device further includes sidewalls extending from the bottom wall. The sidewalls combine with the bottom wall to define a receptacle. The sidewalls include a sidewall that includes an opening. In response to the receptacle receiving an electronic device, the opening is aligned with a port of the electronic device. In response to receiving a cable assembly, the opening is configured to expand.

Clause C: An accessory device include a bottom wall. The accessory device further includes sidewalls extending from the bottom wall. The sidewalls combine with the bottom wall to define a receptacle. The sidewalls include a sidewall that includes a first material and a second material coupled with the first material. The second material defines an opening. In response to receiving a cable assembly at the opening, the second material is configured to move relative to the first material.

One or more of the above clauses can include one or more of the features described below. It is noted that any of the following clauses may be combined in any combination with each other, and placed into a respective independent clause, e.g., clause A, B, or C.

Clause 1: wherein in response to the object being removed, the opening transitions to the first area.

Clause 2: wherein the second area is greater than the first area.

Clause 3: wherein the opening is configured to expand, to the second area, along a first dimension and a second dimension.

Clause 4: wherein further including a material that surrounds the opening, the material configured to compress based on contact with the object.

Clause 5: further including: a first magnet and a second magnet configured to magnetically couple with the first magnet in response to the opening having the first area.

Clause 6: wherein the first magnet and the second magnet are configured to decouple in response to the opening having the second area.

Clause 7: further including: a first door portion and a second door portion. The first door portion and the second door portion are configured to move in response to receiving the object.

Clause 8: further including: a first biasing mechanism coupled with the first door portion; and a second biasing mechanism coupled with the second door portion. The first biasing mechanism and the second biasing mechanism maintain the opening at the first area, and compress in response to the opening receiving the object.

Clause 9: wherein the one or more walls includes a flap configured to bend toward the electronic device.

Clause 10: wherein in response to removing the cable assembly, the opening is configured to contract.

Clause 11: wherein the opening includes a size and shape to receive a connector of the cable assembly, and expand in response to engaging a boot of the cable assembly.

Clause 12: further including a first material that forms, in part, the wall, and a second material that surrounds the opening. The second material is different from the first material.

Clause 13: wherein the opening includes a chamfered opening based on the second material.

Clause 14: wherein the second material is configured to bend in response to the opening receiving the cable assembly.

Clause 15: wherein the sidewall includes a mesh material that defines the opening. Clause 16: wherein the second material includes a mesh material.

Clause 17: wherein in response to receiving the cable assembly, the opening is configured to expand.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An accessory device, comprising:
one or more walls that define a receptacle for an electronic device, the one or more walls comprising an opening having a first area, wherein in response to receiving an object configured to connect to the electronic device, the opening transitions to a second area different from the first area.

2. The accessory device of claim 1, wherein in response to the object being removed, the opening transitions to the first area.

3. The accessory device of claim 1, wherein the second area is greater than the first area.

4. The accessory device of claim 1, wherein the opening is configured to expand, to the second area, along a first dimension and a second dimension.

5. The accessory device of claim 1, wherein further comprising a material that surrounds the opening, the material configured to compress based on contact with the object.

6. The accessory device of claim 1, further comprising:
a first magnet; and
a second magnet configured to magnetically couple with the first magnet in response to the opening having the first area.

7. The accessory device of claim 6, wherein the first magnet and the second magnet are configured to decouple in response to the opening having the second area.

8. The accessory device of claim 1, further comprising:
a first door portion; and
a second door portion, wherein the first door portion and the second door portion are configured to move in response to receiving the object.

9. The accessory device of claim 8, further comprising:
a first biasing mechanism coupled with the first door portion; and
a second biasing mechanism coupled with the second door portion, wherein the first biasing mechanism and the second biasing mechanism:
maintain the opening at the first area, and
compress in response to the opening receiving the object.

10. The accessory device of claim 1, wherein the one or more walls comprises a flap configured to bend toward the electronic device.

11. An accessory device, comprising:
a bottom wall; and
sidewalls extending from the bottom wall, the sidewalls combining with the bottom wall to define a receptacle, the sidewalls comprise a sidewall that includes an opening, wherein:
in response to the receptacle receiving an electronic device, the opening is aligned with a port of the electronic device, and
in response to receiving a cable assembly, the opening is configured to expand.

12. The accessory device of claim 11, wherein in response to removing the cable assembly, the opening is configured to contract.

13. The accessory device of claim 11, wherein the opening includes a size and shape to:
receive a connector of the cable assembly, and
expand in response to engaging a boot of the cable assembly.

14. The accessory device of claim 11, further comprising:
a first material that forms, in part, the wall; and
a second material that surrounds the opening, the second material different from the first material.

15. The accessory device of claim 14, wherein the opening comprises a chamfered opening based on the second material.

16. The accessory device of claim 14, wherein the second material is configured to bend in response to the opening receiving the cable assembly.

17. The accessory device of claim 11, wherein the sidewall comprises a mesh material that defines the opening.

18. An accessory device, comprising:
a bottom wall; and
sidewalls extending from the bottom wall, the sidewalls combining with the bottom wall to define a receptacle, the sidewalls comprise a sidewall that includes:
a first material; and
a second material coupled with the first material, the second material defining an opening, wherein in response to receiving a cable assembly at the opening, the second material is configured to move relative to the first material.

19. The accessory device of claim 18, wherein the second material comprises a mesh material.

20. The accessory device of claim 18, wherein in response to receiving the cable assembly, the opening is configured to expand.
